(19) United States
(12) Patent Application Publication
(10) Pub. No.: US 2007/0019395 A1
(43) Pub. Date: Jan. 25, 2007

(54) Electronic device

(75) Inventors: Ching-Sung Yeh, Taipei (TW); Yu-Chi Lee, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/488,825

(22) Filed: Jul. 19, 2006

(30) Foreign Application Priority Data
Jul. 19, 2005 (TW) 94124407

(51) Int. Cl. G01D 11/28

(52) U.S. Cl. 362/29

(57) ABSTRACT

An electronic device is disclosed, comprising: a transparent body including an outer surface and an inner surface on opposite sides; a transparent film deposed on the outer surface of the transparent body; an opaque film deposed on the inner surface of the transparent body, wherein a pattern structure is formed in the opaque film, and the pattern structure exposes a portion of the inner surface of the transparent body; and a light source corresponding to a location of the pattern structure.

### RELATED APPLICATIONS

The present application is based on, and claims priority from, Taiwan Application Serial Number 94124407, filed Jul. 19, 2005, the disclosure of which is hereby incorporated by reference herein in its entirety.

### FIELD OF THE INVENTION

The present invention relates to an electronic device, and more particularly, to a computer device having a pattern-displaying design.

### BACKGROUND OF THE INVENTION

Currently, the design for displaying patterns of a typical electronic device usually uses light-guiding pillars to transmit beams of light. FIG. 1 illustrates a schematic diagram of a pattern-displaying installation of a conventional electronic device. A plurality of openings 110 are set in an upper housing 100 of an electronic device, in which the amount of the openings is the same as that of patterns desired to be displayed. Each opening 110 is set with a light-guiding pillar 106, such as shown in FIG. 1. Before the light-guiding pillars 106 are installed, outer surfaces of the light-guiding pillars 106 are sprayed with paint, and a front end 114 of each light-guiding pillar 106 is carved with the desired pattern by a laser carving method. In another method for installing patterns, a polycarbonate (PC) film is provided, on which the patterns are printed, that is adhered to an inner surface of the upper housing 100, and a light-guiding pillar 106 is set under each pattern by a thermal melt method.

An independent light source 104 is set under each light-guiding pillar 106, in which these light sources 104 are fixed on a lower housing 102, and the light source 104 is separated from the corresponding light-guiding pillar 106 by a gap to prevent the light source 104 from being pressed and being cracked by the light-guiding pillar 106 during usage or assembly. The body of the upper housing 100 is usually transparent, so a mylar film 112 is adhered to the inner surface of the sidewalls of the upper housing 100 to obstruct the unguided light produced by the light source 104, thereby preventing an unexpected pattern from displaying.

However, when the components, such as light-guiding pillars and the mylar films, are used, one has to fabricate molds and then uses the molds to fabricate the light-guiding pillars and the mylar films according to the product requirements, making assembly of the device inconvenient and greatly increasing the fabrication cost. Moreover, the conventional design of the pattern-displaying device may alter the surface appearance of the display area, hampering the aesthetic design of the electronic product.

### SUMMARY OF THE INVENTION

Therefore, one objective of the present invention is to provide an electronic device, in which no light-guiding pillar and mylar film is needed, thereby reducing the fabrication cost and having an advantage of easy assembly.

Another objective of the present invention is to provide an electronic device, in which a light-guiding design for displaying a pattern does not need to debase the surface appearance of the display region but instead compliments the aesthetic design of the device.

According to the aforementioned objectives, the present invention provides an electronic device, comprising: a transparent body including an outer surface and an inner surface on opposite sides; a transparent film deposed on the outer surface of the transparent body; an opaque film deposed on the inner surface of the transparent body, wherein a pattern structure is formed in the opaque film, and the pattern structure exposes a portion of the inner surface of the transparent body; and a light source corresponding to a location of the pattern structure.

According to a preferred embodiment of the present invention, the electronic device is preferably a notebook. Furthermore, the transparent film may be an undertone coating, and the opaque film may be a dark coating. The pattern structures in the opaque film may be formed by a laser carving method.

According to the other objectives, the present invention provides a method for assembling a pattern-displaying device, comprising the following steps. An upper housing is provided, wherein the upper housing comprises: a transparent body including an outer surface and an inner surface on the opposite sides, a transparent film deposed on the outer surface of the transparent body, and an opaque film deposed on the inner surface of the transparent body. At least one pattern structure is formed in the opaque film, and the at least one pattern structure exposes a portion of the inner surface of the transparent body. Next, a lower housing is put in the upper housing relatively. Then, a light source is installed on a surface of the lower housing, which faces the upper housing, wherein the location of the light source corresponds to that of the at least one pattern structure.

By coating a transparent film and an opaque film on an outer surface and an inner surface of the transparent body of the upper housing respectively, and etching patterns in the opaque film, the patterns in the opaque film can be clearly shown on the transparent film located on the outer surface of the transparent body by the underlying light sources. Therefore, with the application of the present invention, no light-guiding pillar or mylar film is needed, and the surface appearance does not need to be debased, thereby achieving the objectives of reducing the fabrication cost, simplifying the assembly procedure and increasing the flexibility of aesthetic design.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a pattern-displaying installation of a conventional electronic device;

FIG. 2a is a top view of an electronic device in accordance with a preferred embodiment of the present invention;

FIG. 2b is a cross-sectional view of a pattern-displaying installation along the cross-sectional line .-.shown in FIG. 2a;

FIG. 2c is a top view of an electronic device in accordance with a preferred embodiment of the present invention, wherein the light sources of the pattern-displaying installation are closed; and

FIG. 2d is a top view of an electronic device in accordance with a preferred embodiment of the present invention, wherein the light sources of the pattern-displaying installation are open.

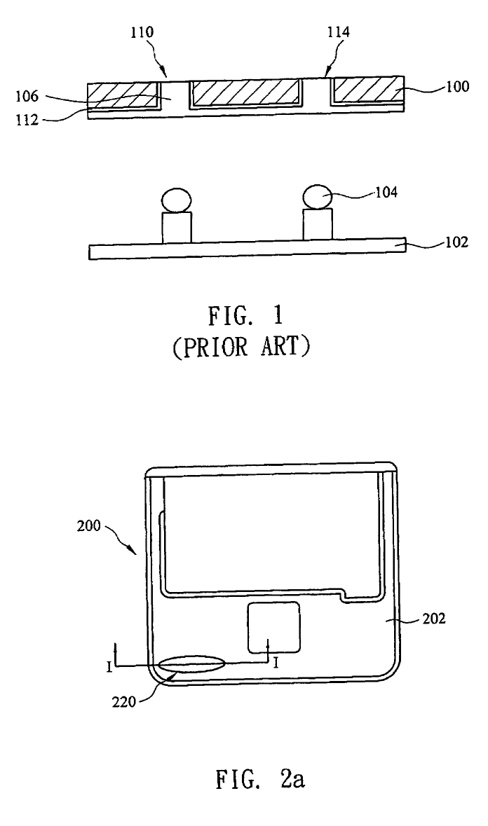

### DETAILED DESCRIPTION OF THE PREFERRED EMBODIMENT

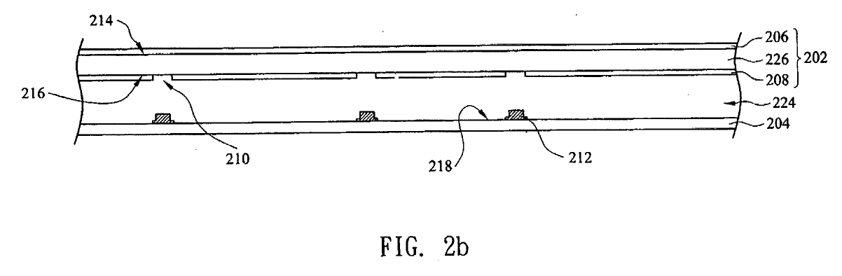

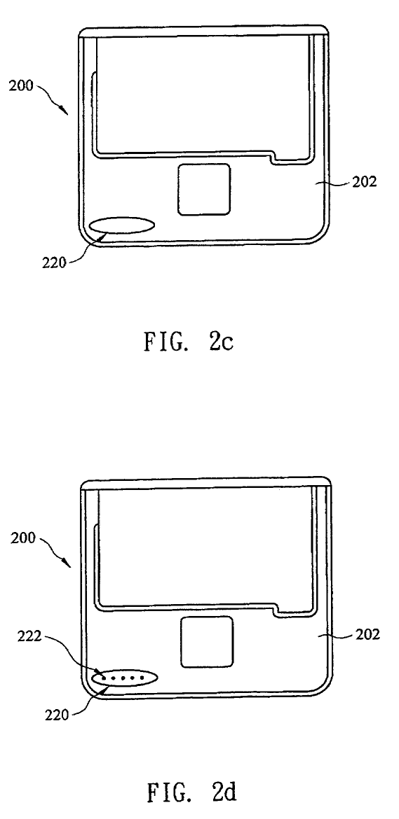

The present invention discloses an electronic device and a method for assembling a pattern-displaying installation thereof. In the present invention, the patterns can be clearly displayed without using either light-guiding pillars or mylar films. In order to make the illustration of the present invention more explicit and complete, the following description is stated with reference to FIGS. 2a to 2d.

FIG. 2a is a top view of an electronic device in accordance with a preferred embodiment of the present invention, and FIG. 2b is a cross-sectional view of a pattern-displaying installation along the cross-sectional line .-.shown in FIG. 2a. The electronic device of the present invention may be a typical electronic product, such as a mobile phone, a personal digital assistant (PDA) or a portable video device, or may be a desktop computer or a notebook computer. In the present preferred embodiment, the electronic device 200 is a notebook computer, such as shown in FIG. 2a. FIG. 2a only illustrates a mainframe of the computer device, and the monitor connected to the mainframe is not shown because the monitor is irrelevant to the aspects of the present invention. Typically, the electronic device includes an upper housing 202 and a lower housing 204, in which the upper housing 202 and the lower housing 204 can be combined to form a cavity 224. For simplification, because the combination of the upper housing 202 and the lower housing 204 is not relevant to the aspects of the present invention, the combination is not illustrated in the drawings, such as FIG. 2b. The electronic component, such as a mainframe, of the electronic device 200 may be set within the cavity 224.

A top surface of the upper housing 202 of the electronic device 200 includes a pattern-displaying region 220 for displaying certain patterns indicating the usage statuses of the electronic device 200, such as the on/off state and the network connection state of the device. One principal feature of the present invention is to provide a pattern-displaying design for an electronic device without using light-guiding pillars and mylar films. The upper housing is mainly composed of a transparent body 226, a transparent film 206 and an opaque film 208, in which the body 226 includes an outer surface 214 and an inner surface 216 on the opposite sides. The transparent film 206 is preferably set on the outer surface 214 of the body 226, and the opaque film 208 is preferably set on the inner surface 216 of the body 226. In some embodiments of the present invention, a material of the body 226 may be polycarbonate, acryl or a combination thereof, the transparent film 206 may be an undertone coating, and the opaque film 208 may be a dark coating. In an exemplary embodiment, the material of the transparent film 206 may be pearl-white paint, and the material of the opaque film 208 may be gray paint. A thickness of the transparent film 206 is, for example, between about 5.m and about 50.m, and is preferably between about 25.m and about 30.m. A thickness of the opaque film 208 is, for example, larger than about 5.m, and is preferably larger than about 15.m. In the present invention, the brightness of the displaying patterns can be controlled by modifying the thickness of the transparent film 206, and the opaque film 208 needs to have a sufficient thickness to at least prevent the surplus light from leaking. However, the opaque film 208 cannot be so thick that the sequential processes for forming pattern structures 210 are hampered.

After the transparent film 206 and the opaque film 208 are formed, a portion of the opaque film 208 is removed by, for example, a laser carving method, until the underlying inner surface 216 of body 226 is exposed, so as to form the pattern structure 210 with the desired pattern in the opaque film 208. Then, light sources 212 are set on an inner surface 218 of the lower housing 204 under each pattern structure 210 respectively, in which positions of the light sources 212 are preferably corresponding to those of the pattern structures 210. The light sources 210 are, for example, cold light sources or light-emitting diodes (LED). The intensity of the light source 212 and the distance between the light source 212 and the inner surface 216 of the body 226 affects the brightness and the clearness of the displaying pattern. When the intensity of the light source 212 is fixed, the distance between the light source 212 and the inner surface 216 of the body 226 may be modified according to the intensity of the light source 212; and when the distance between the light source 212 and the inner surface 216 of the body 226 is fixed, the light source 212 of appropriate intensity may be provided according to the distance between the light source 212 and the inner surface 216. In an embodiment, the distance between the light source 212 and the inner surface 216 of the body 226 is between about 2 mm and about 3 mm, and is preferably about 2.7 mm.

In the application, when the light sources are turned off, no pattern is shown on the pattern-displaying region 220 of the upper housing 202, and the structure of the appearance surface is flat, such as shown in FIG. 2c. On the other hand, as shown in FIG. 2d, when the light sources are turned on, a portion of the light projected upwardly by the light sources 212 is blocked by the opaque film 208, and the other portion of the light passes through the body 226 from the inner surface 216 exposed by the corresponding pattern structure 210, so that the pattern of the pattern structure 210 can be projected to and pass through the transparent film 206 to show a corresponding pattern 222 on the pattern-displaying region 220 on the top surface of the transparent film 206.

According to the aforementioned description, one advantage of the present invention is that because the present electronic device does not need to use a light-guiding pillar and a mylar film, the present electronic device does not need to use a polycarbonate film and perform a print treatment thereon. Therefore, the cost of fabricating the molds of the light-guiding pillars and the mylar films can be avoided, and the assembly of the electronic device is easy, thereby greatly reducing the fabrication cost.

According to the aforementioned description, another advantage of the present invention is that because in the present electronic device, the light-guiding design for displaying patterns does not need to alter the surface structure in the display region, the electronic device can maintain a flush surface in the pattern-displaying region to further achieve the objective of enhancing the flexibility of the aesthetic design.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An electronic device, comprising:
a transparent body including an outer surface and an inner surface on opposite sides;
a transparent film deposed on the outer surface of the transparent body;
an opaque film deposed on the inner surface of the transparent body, wherein a pattern structure is formed in the opaque film, and the pattern structure exposes a portion of the inner surface of the transparent body; and
a light source corresponding to a location of the pattern structure.

2. The electronic device according to claim 1, wherein the electronic device is a mobile phone, a personal digital assistant, a desktop computer, a notebook computer or a portable video device.

3. The electronic device according to claim 1, wherein a material of the transparent body is selected from the group consisting of polycarbonate, acryl and a combination thereof.

4. The electronic device according to claim 1, wherein the transparent film is pearl white paint.

5. The electronic device according to claim 1, wherein a thickness of the transparent film is between about 5.m and about 50.m.

6. The electronic device according to claim 1, wherein a thickness of the transparent film is between about 25.m and about 30.m.

7. The electronic device according to claim 1, wherein the opaque film is gray paint.

8. The electronic device according to claim 1, wherein a thickness of the opaque film is larger than about 5.m.

9. The electronic device according to claim 1, wherein a thickness of the opaque film is larger than about 15.m.

10. The electronic device according to claim 1, wherein the light source is a light-emitting diode.

11. The electronic device according to claim 1, wherein a distance between the light source and the inner surface of the transparent body is between about 2 mm and about 3 mm.
